(19) United States
(12) Patent Application Publication
(10) Pub. No.: US 2012/0038241 A1
(43) Pub. Date: Feb. 16, 2012

(54) DEVICE FOR AXIAL TENSIONING OF A STATOR COIL OF AN ELECTRICAL MACHINE

(75) Inventor: Hossein Safari Zadeh, Othmarsingen (CH)

(73) Assignee: ALSTOM TECHNOLOGY LTD, Baden (CH)

(21) Appl. No.: 13/229,809

(22) Filed: Sep. 12, 2011

Related U.S. Application Data
(63) Continuation of application No. PCT/EP2010/052569, filed on Mar. 1, 2010.

(30) Foreign Application Priority Data
Mar. 11, 2009 (CH) 00363/09

(51) Int. Cl. H02K 3/46

(52) U.S. Cl. 310/260

(57) ABSTRACT

An apparatus axial stresses a stator winding of an electrical machine, the winding including a plurality of winding bars, the ends of the winding bars passing axially out of a core of a stator and forming a widened end winding at least one axial end face of the core. A plurality of winding supports is distributed circumferentially and substantially at a right angle with respect to the end winding on the at least one axial end face of the core. At least one axially acting compression spring device is configured to support the plurality of winding supports on the at least one axial end face of the core and to axially stress the plurality of winding supports. A readjusting device communicates with at least one of the plurality of winding supports and has an axially adjustable contact surface, the at least one axially acting compression spring device being axially supported on the core and on the axially adjustable contact surface of the readjusting device.

### CROSS REFERENCE TO PRIOR APPLICATIONS

This is a continuation of International Patent Application No. PCT/EP2010/052569, filed on Mar. 1, 2010, which claims priority to Swiss Application No. CH 00363/09, filed Mar. 11, 2009. The entire disclosure of both applications is incorporated by reference herein.

### FIELD

The present invention relates to an apparatus for axial stressing of a stator winding of an electrical machine, in particular of a generator in a power station.

### BACKGROUND

Normally, a stator, in particular a generator stator in a power station, has a core and a winding which has a plurality of winding bars. The ends of these winding bars are passed out of the core at least on one axial end face of the core of the stator, and are bent around and connected to one another such that they form an end winding on the end face of the core, which widens in the form of a funnel or conically as the distance from the core increases. For operation of the generator, this end winding must be supported under tensile stress on the core in the axial direction of the stator, that is to say axially. Furthermore, it is necessary to load the end winding radially from the outside inward by prestressing. This stressing or supporting of the end winding is necessary in order to make it possible to absorb the electrical dynamic forces which occur during operation. In some cases, the desired stressing of the winding or of the end winding is applied even while the stator is being produced. However, settling processes and the like can occur during operation of the stator, and can have a disadvantageous effect on the stress acting on the winding or on the end winding.

DE 103 30 523 A1 describes an apparatus for axial stressing of a winding of a stator. The winding supports are supported axially on one end face of a core, via at least one axially acting compression-spring device, for axial stressing of the winding. The individual compression-spring devices may be supported on a supporting ring which is close to the core and is itself supported axially on the winding supports. The supporting ring which is close to the core extends in the circumferential direction and is closed. The supporting ring which is close to the core is expediently firmly connected to each winding support, for example by means of a screw connection. After maintenance or after heat treatment of the supporting apparatus, it is possible that the spring devices will not exert the optimum force on the supporting ring, and this leads to excessively high or excessively low prestressing of the winding bars.

### SUMMARY OF THE INVENTION

In an embodiment, the present invention provides an apparatus for axial stressing of a stator winding of an electrical machine, the winding including a plurality of winding bars, the ends of the winding bars passing axially out of a core of a stator and forming a widened end winding at least one axial end face of the core. A plurality of winding supports is distributed circumferentially and substantially at a right angle with respect to the end winding on the at least one axial end face of the core. At least one axially acting compression spring device is configured to support the plurality of winding supports on the at least one axial end face of the core and to axially stress the plurality of winding supports. A readjusting device communicates with at least one of the plurality of winding supports and has an axially adjustable contact surface, the at least one axially acting compression spring device being axially supported on the core and on the axially adjustable contact surface of the readjusting device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a simplified axial section through a stator in the area of an apparatus for axial stressing of a winding, having a readjusting apparatus according to the invention,

FIG. 2 shows details of a compression-spring device as shown in FIG. 1,

FIG. 3 shows a component of the readjusting apparatus according to one preferred embodiment of the invention,

FIG. 4 shows an axially adjustable contact surface of a readjusting apparatus according to the invention, and

FIG. 5 shows a rear view of a readjusting apparatus according to the invention.

### DETAILED DESCRIPTION

An aspect of the invention deals with the problem of providing the capability to readjust the forces acting on the winding, for an apparatus for axial stressing of a winding of a stator, in particular of a generator stator in a power station.

According to an embodiment of the invention, winding supports are provided for axial stressing of the winding and are supported axially on an end face of a core via at least one axially acting compression-spring device, with a readjusting apparatus being provided, with an axially adjustable contact surface for the compression-spring device. The axially adjustable contact surface for the compression-spring device allows the prestressing of the windings to be retrospectively adjusted after maintenance or after heat treatment.

In one advantageous refinement of the invention, a supporting ring is provided, which is close to the core, extends in the circumferential direction and is supported axially on the winding supports, with the supporting ring being provided with the axially adjustable contact surface.

In one preferred embodiment, the axially adjustable contact surface for the compression-spring device is the head of a screw or of a bolt. The screw or the bolt can be provided in the supporting ring, with the axial position of the head being adjustable by rotation of the screw or of a nut.

Further advantages and refinements of the invention will become evident from the following description and the attached drawings.

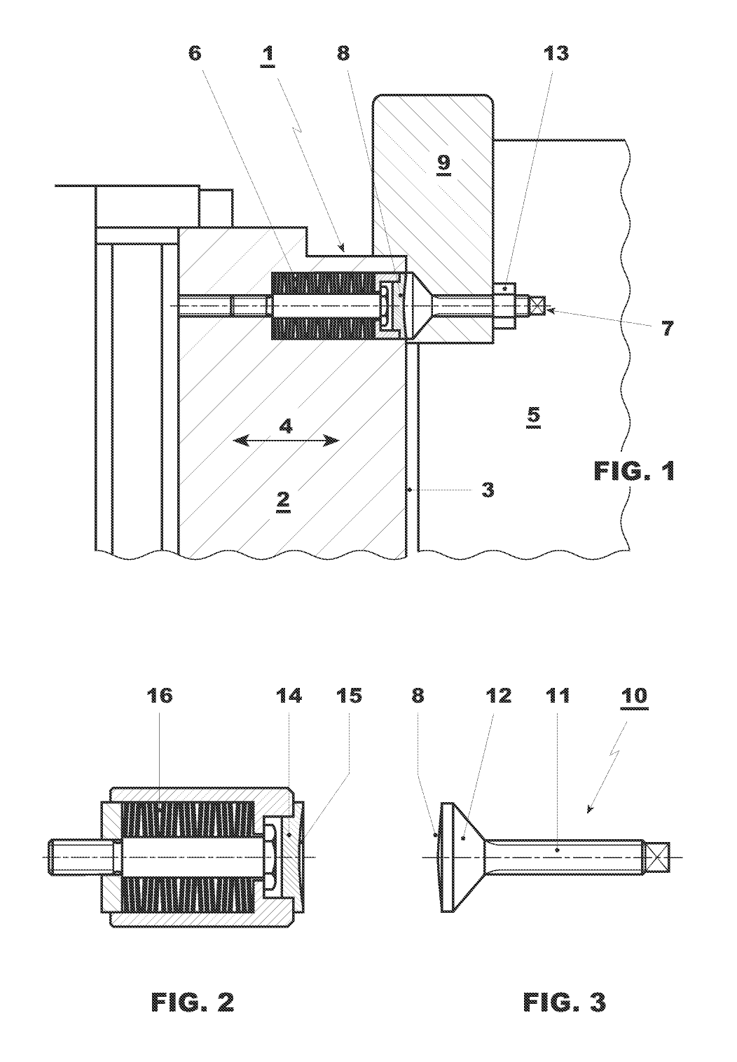

FIG. 1 shows a section illustration through a stator in the area of an apparatus 1 for axial stressing of a winding. A winding such as this normally has a plurality of winding bars. The ends of these winding bars are passed out of the core 2, at least on one axial end face 3 of a core 2 of the stator, and are bent around and connected to one another such that they form an end winding on the end face 3 of the core, which widens in the form of a funnel or conically as the distance from the core 2 increases. For operation of the stator, this end winding must be supported on the core 3 in the axial direction of the stator (indicated by the double-headed arrow 4), that is to say with an axial tensile stress. A plurality of winding supports 5 are provided for this purpose and are arranged distributed circumferentially with respect to the end winding on the end face 3 of the core 2, and are supported axially on the end face 3 of the core 2, and at right angles on the end winding. As used herein, at right angles means essentially at right angles. The end face 3 of the core 2 comprises at least one spring device 6, via which a winding support 5 is supported axially on the end face 3 of the core 2. A plurality of spring devices 6 are preferably provided in the core 2 and are arranged distributed circumferentially in order to support the winding supports 5. The spring device 6 applies an axially acting force on the winding supports 5, and allows prestressing of the winding bars. The winding supports 5 can be supported on the core 2 by means of a supporting ring 9 which extends in the circumferential direction. The supporting ring 9 can expediently be firmly connected to each winding support 5, for example by means of a screw connection.

According to the invention, a readjusting apparatus 7 is provided having an axially adjustable contact surface 8 for the compression-spring device 6. The readjusting apparatus 7 can be arranged on the supporting ring 9, as can be seen in FIG. 1. The readjusting apparatus 7 with the contact surface 8 for the compression-spring device 6 may, however, also be arranged on the winding support 5 itself.

FIG. 2 schematically illustrates the basic design of the compression-spring device 6 within the core 2. A cup-spring pack 16 can be seen, which applies the prestressing force for the winding supports 5. The design and method of operation of the compression-spring device 6 are not described at this point. The figure shows a cover disk 14 on the compression-spring device 6. A contact surface 8 of the readjusting apparatus 7 is supported directly on a contact surface 15 of this cover disk 14. The interacting contact surfaces 8 and 15 of the compression-spring device 6 and of the readjusting apparatus 7 may, in the simplest case, be planar. According to one preferred embodiment of the invention, the cover disk 14 is equipped with a concave contact surface 15, in order to interact with a convex contact surface 8 on the readjusting apparatus 7.

FIG. 3 shows one preferred embodiment of the readjusting apparatus 7. The readjusting apparatus 7 is illustrated in the form of a screw or of a bolt 10. The connection between the threaded shank 11 and the head 12 may be both rigid and articulated (as in the case of articulated feet). The head or the contact plate 12 acts as contact surface 8 for the cover disk 14 of the spring device 6, and is positioned essentially aligned with the spring device 6. The convex shape of the contact surface 8, in conjunction with the concave shape of the complementary contact surface 15, has a self-centering effect. This not only simplifies assembly, but also reduces the risk of lateral displacement during transient operating states.

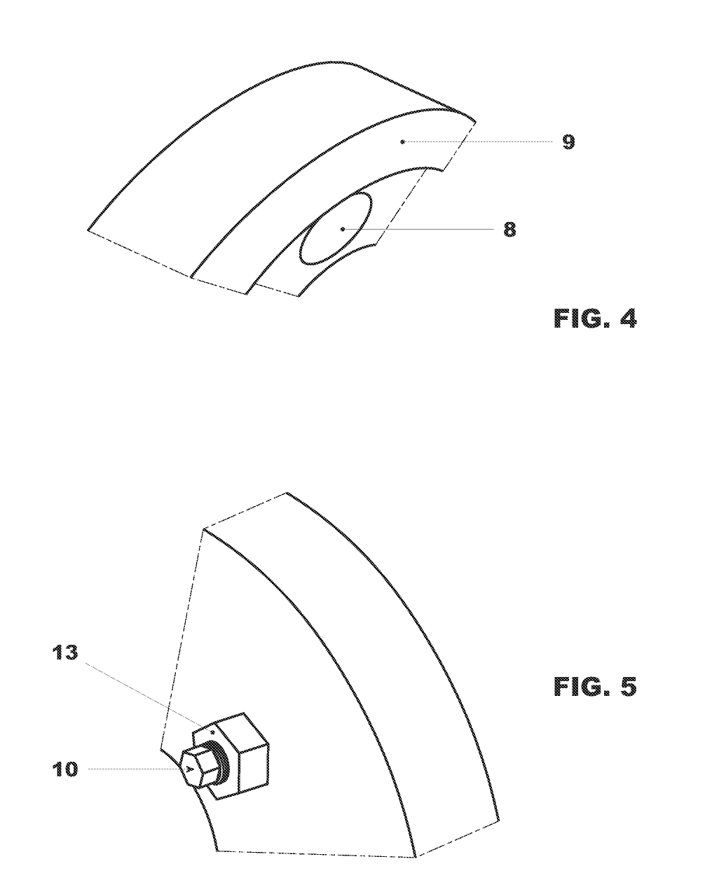

The preferred installation position of the spring device 6 is illustrated in FIGS. 4 and 5. These figures show that the screw or the bolt 10 is installed within the supporting ring 9. For this purpose, the supporting ring 9 can be provided with an aperture hole with an internal thread.

Before heat treatment, the screw or the bolt 10 is screwed into the supporting ring 9 until the contact surface 8 is completely flush with the surface of the supporting ring 9. After maintenance or heat treatment, the axial height of the contact surface 8 can be adjusted by rotating the screw or the bolt 10, in order in this way to apply the desired prestress to the winding. A nut 13 can be used to secure the bolt 10 against rotation and is secured against inadvertently becoming loose in a manner known per se, for example by means of a toothed washer. As used herein, flush means essentially flush.

Alternatively, the axial height of the contact surface 8 can be adjusted by rotating a nut 13 which is arranged between the supporting ring 9 and the winding support 5.

The supporting ring 9 may be closed and, as is illustrated in FIG. 1, may have an inner circumferential surface which rests on a radial outer surface of the core 2. Expediently, a plurality of readjusting apparatuses 7 are arranged distributed over the circumference of the supporting ring 9, to be precise such that they are positioned directly opposite the compression-spring devices 6.

The above description of the exemplary embodiments according to the present invention is intended only for illustrative purposes and not for the purpose of restricting the invention. Particularly with respect to a number of preferred exemplary embodiments, it will be evident from it to a person skilled in the art that various changes and modifications in form and details can be made without departing from the idea and scope of the invention. The disclosure of the present invention should accordingly not be considered restrictively. Instead, the disclosure of the present invention is intended to illustrate the scope of the invention, which is described in the following claims.

### LIST OF REFERENCE SYMBOLS

1 Stressing apparatus
2 Core
3 End face of the core
4 Axis direction (axial direction)
5 Winding support
6 Compression-spring device
7 Readjusting apparatus
8 contact surface
9 Supporting ring
10 Bolt
11 Threaded shank
12 Head
13 Nut
14 Cover disk
15 Contact surface
16 Cup-spring pack

What is claimed is:

1. An apparatus for axial stressing of a stator winding of an electrical machine, the winding including a plurality of winding bars, the ends of the winding bars passing axially out of a core of a stator and forming a widened end winding at least one axial end face of the core, the apparatus comprising:
a plurality of winding supports distributed circumferentially and substantially at a right angle with respect to the end winding on the at least one axial end face of the core;
at least one axially acting compression spring device configured to support the plurality of winding supports on the at least one axial end face of the core and to axially stress the plurality of winding supports; and
a readjusting device communicating with at least one of the plurality of winding supports and having an axially adjustable contact surface, the at least one axially acting compression spring device being axially supported on the core and on the axially adjustable contact surface of the readjusting device.

2. The apparatus as recited in claim 1, wherein the electrical machine is a generator at a power station.

3. The apparatus as recited in claim 1, further comprising a supporting ring disposed close to the core and extending in a circumferential direction and supported axially on the plurality of winding supports, wherein the readjusting device is disposed in the supporting ring.

4. The apparatus as recited in claim 3, wherein the supporting ring is closed and firmly connected to each of the plurality of winding supports.

5. The apparatus as recited in claim 1, wherein the readjusting device is at least one of a screw and a bolt having a threaded shank connected to the supporting ring and a head having a contact surface.

6. The apparatus as recited in claim 5, wherein at least one of the screw and the bolt is disposed in a completely screwed-in position such that the contact surface of the head is flush with a surface of at least one of the supporting ring and the core.

7. The apparatus as claimed in claim 5, wherein the head is connected to the threaded shank in an articulate manner.

8. The apparatus as recited in claim 1, wherein the compression spring device includes a cover disk having a contact surface interacting with the axially adjustable contact surface of the readjusting device.

9. The apparatus as recited in claim 8, wherein the contact surface of the cover disk is concave, and the axially adjustable contact surface of the readjusting device is convex.

10. The apparatus as recited in claim 8, wherein the contact surface of the cover disk is convex, and the axially adjustable contact surface of the readjusting device is concave.
